(19) United States
(12) Patent Application Publication
(10) Pub. No.: US 2007/0053119 A1
(43) Pub. Date: Mar. 8, 2007

(54) Earth leakage detection device

(75) Inventor: Akihiro Goto, Yokohama-shi (JP)

Correspondence Address: COHEN, PONTANI, LIEBERMAN & PAVANE, 551 FIFTH AVENUE, SUITE 1210, NEW YORK, NY, 10176, US

(73) Assignee: HST Co., Ltd., Tokyo (JP)

(21) Appl. No.: 11/592,951

(22) Filed: Nov. 3, 2006

Related U.S. Application Data
(63) Continuation of application No. PCT/JP05/08497, filed on May 10, 2005.

(30) Foreign Application Priority Data
May 13, 2004 (JP) 2004-143146

(51) Int. Cl. H02H 3/00

(52) U.S. Cl. 361/42

(57) ABSTRACT

Disclosed is an earth leakage detection device, which comprises a printed-circuit board incorporating an earth-leakage-detection control circuit, a reset function-equipped switch mounted on the side of one of opposite surfaces of the printed-circuit board, an earth-leakage-detecting current transformer mounted on the side of the other surface of the printed-circuit board, an externally connecting terminal for introducing and outputting an electrical power, and an electrical wire member arranged to penetrate through the earth-leakage-detecting current transformer and connected relative to the externally connecting terminal. In this earth leakage detection device, the reset function-equipped switch is connected to the earth-leakage-detection control circuit with the interposition of the externally connecting terminal therebetween. According to the present invention, components of the earth leakage detection device are arranged above and below the printed-circuit board in a compact manner using a significantly simple mechanisrh. Thus, the earth leakage detection device can be reduced in size and cost, and suitably arranged in a housing for various apparatuses, such as a copier and a printer.

### RELATED APPLICATION

This application is a U.S. Continuation Application of International Application PCT/JP2005/008497 filed May 10, 2005.

### TECHNICAL FIELD

The present invention relates to an earth leakage detection device, and more particularly to an earth leakage detection device suited to be arranged and used in a housing for various apparatuses, such as a copier and a printer.

### BACKGROUND ART

Heretofore, as a device for detecting earth leakage to break a circuit, there has been known an earth leakage breaker. The conventional earth leakage breaker includes various types, as disclosed, for example, in Japanese Patent Laid-Open Publication Nos. 2000-261953, 2001-023501 and 2001-006515.
[Patent Publication 1] Japanese Patent Laid-Open Publication No. 2000-261953
[Patent Publication 2] Japanese Patent Laid-Open Publication No. 2001-023501
[Patent Publication 3] Japanese Patent Laid-Open Publication No. 2001-006515

### DISCLOSURE OF THE INVENTION

Most of the conventional earth leakage breakers are designed for in-house wiring equipment, and therefore it is difficult to assure a layout space in a currently prevailing apparatus, such as a copier or a printer, so as to arrange the conventional earth leakage breaker thereinside without modifications. Moreover, the conventional earth leakage breakers have a complicated mechanism due to an overcurrent detecting function added thereto, which is likely to cause an undesirable increase in cost.

Further, there has been little progress in downsizing of the conventional earth leakage breakers due to a relatively low need therefor. Thus, even if some of the conventional earth leakage breakers can be used in the above apparatus, there remain various problems, for example, in terms of effective utilization of space in the apparatus.

When it is attempted to arrange an earth leakage detection device in the above apparatus, an earth leakage detection device for a switch segment involves the need for arranging it at a position convenient for manual operation. In reality, the conventional earth leakage breakers cannot meet this need because they are designed to integrate a switch segment and a control circuit segment together in an inseparable manner, resulting in poor flexibility in design of the apparatus. Moreover, depending on layout positions in the apparatus, the conventional earth leakage breakers involve the necessity for arranging a power switch separately due to difficulty in using the switch segment as the power switch.

It is therefore an object of the present invention to provide an earth leakage detection device capable of solving the above problems of the conventional technique.

In order to achieve the above object, the present invention provides an earth leakage detection device which comprises a printed-circuit board incorporating an earth-leakage-detection control circuit, a reset function-equipped switch mounted on the side of one of opposite surfaces of the printed-circuit board, an earth-leakage-detecting current transformer mounted on the side of the other surface of the printed-circuit board, an externally connecting terminal for introducing and outputting an electrical power, and an electrical wire member arranged to penetrate through the earth-leakage-detecting current transformer and connected relative to the externally connecting terminal. In this earth leakage detection device, the reset function-equipped switch is connected to the earth-leakage-detection control circuit with the interposition of the externally connecting terminal therebetween.

In one embodiment of the present invention, the earth leakage detection device has a functional block connection segment including a flat plate-shaped anchor member provided with a connection terminal. In this case, the reset function-equipped switch is adapted to be detachable relative to the connection terminal, and the printed-circuit board constitutes an earth-leakage-detection control circuit segment. Further, the earth-leakage-detecting current transformer and the electrical wire member are associated with the printed-circuit board.

In another embodiment of the present invention, the functional block connection segment and the earth-leakage-detection control circuit segment are adapted to be detachable relative to each other.

In yet another embodiment of the present invention, the connection terminal is a Faston terminal.

In still another embodiment of the present invention, the externally connecting terminal includes a first externally connecting terminal for introducing an electrical power and a second externally connecting terminal for outputting the electrical power. The first and second externally connecting terminals are disposed on the same side of the earth leakage detection device.

In yet still another embodiment of the present invention, the first externally connecting terminal and the second externally connecting terminal are disposed, respectively, on opposite sides of the earth leakage detection device.

In another further embodiment of the present invention, the reset function-equipped switch additionally serves as a power switch.

As above, according to the present invention, components of the earth leakage detection device are arranged above and below the printed-circuit board in a compact manner using a significantly simple mechanism. Thus, the earth leakage detection device can be reduced in size and cost, and suitably arranged in a housing for various apparatuses, such as a copier and a printer.

According to the present invention, a switch segment and a control circuit segment can be separated from reach other. Thus, for example, only the switch segment may be arranged at a position convenient for manual operation to provide enhanced flexibility in design of the device. The reset function-equipped switch capable of being separated using an appropriate harness, such as an electrical wire, can be designed for operationality even when used as a power switch. Further, the reset function-equipped switch has excellent adaptability to change in rated values thereof.

According to the present invention, the earth-leakage-detection control circuit segment can be separated so as to cope with the need for change in specification of leakage current, change in breaking time during detection of earth leakage, etc.

According to the present invention, the earth leakage detection device can be mounted to an apparatus having an existing reset function-equipped switch to add a earth leakage detection function so as to facilitate ensuring safety.

According to the present invention, directions for connection to a commercial power supply and a load can be changed only based on how to form connection strips and the externally connecting terminals in the functional block connection segment to provide enhanced flexibility in layout of the device.

### BRIEF DESCRIPTION OF DRAWINGS

FIG. 1 is a schematic front view of an earth leakage detection device according to one embodiment of the present invention.

FIG. 2 is a schematic side view of the earth leakage detection device in FIG. 1.

FIG. 3 is a schematic top plan view of the earth leakage detection device in FIG. 1.

FIG. 4 is a schematic bottom view of the earth leakage detection device in FIG. 1.

FIG. 5 is a schematic front view showing a reset function-equipped switch of the earth leakage detection device in FIG. 1.

FIG. 6 is a schematic front view showing a functional block connection segment of the earth leakage detection device in FIG. 1.

FIG. 7 is a schematic front view showing an earth-leakage-detection control circuit segment of the earth leakage detection device in FIG. 1.

FIG. 8 is a schematic bottom view of the earth-leakage-detection control circuit segment in FIG. 7.

FIG. 9 is a block diagram showing an electrical connection and arrangement of each component in one example of implementation of the earth leakage detection device illustrated in FIGS. 1 to 8.

FIG. 10 is a schematic front view of an earth leakage detection device according to another embodiment of the present invention.

### BEST MODE FOR CARRYING OUT THE INVENTION

With reference to the accompanying drawings, an embodiment of the present invention will now be specifically described.

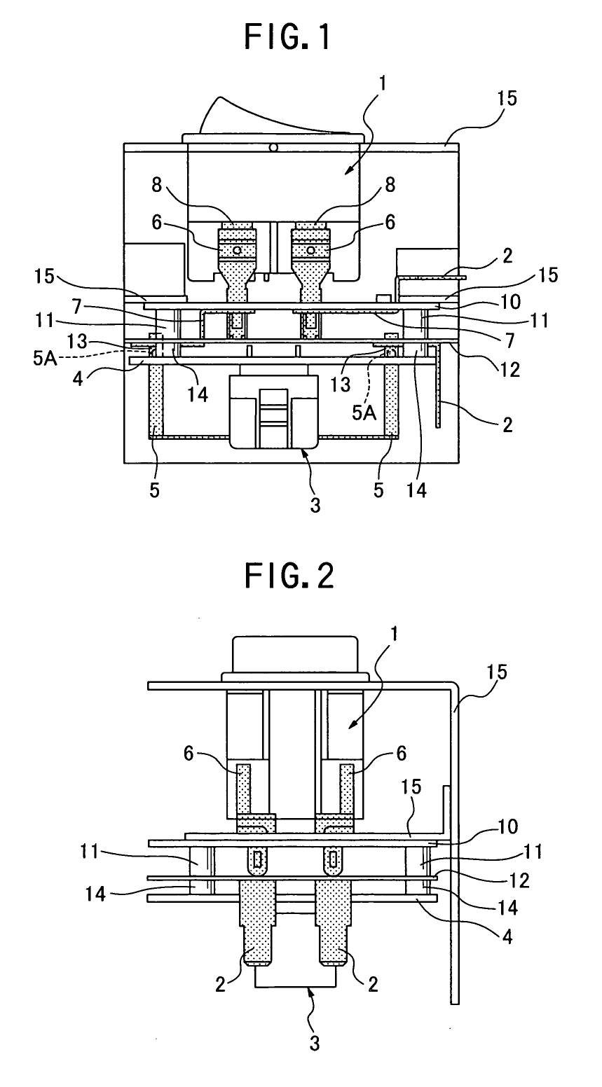

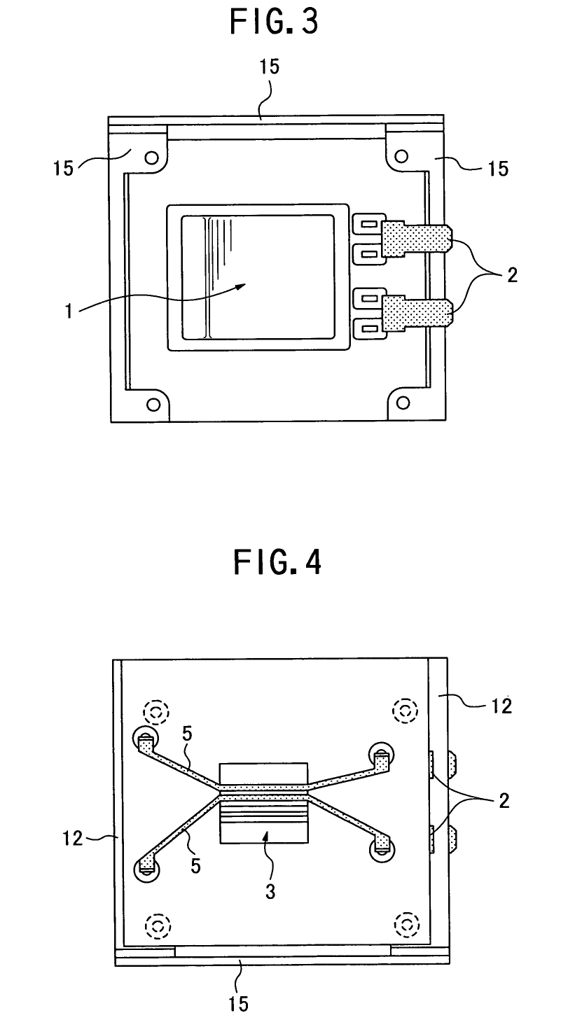

In the accompanying drawings, FIG. 1 is a schematic front view of an earth leakage detection device according to one embodiment of the present invention. FIGS. 2, 3 and 4 are, respectively, a schematic side view, a schematic top plan view and a schematic bottom view of the earth leakage detection device in FIG. 1. In FIGS. 1 to 4, the earth leakage detection device is illustrated in a state when it is held by a bracket for attachment to an apparatus. As schematically shown in FIGS. 1 to 4, the earth leakage detection device according to this embodiment primarily comprises a reset function-equipped switch (i.e. a switch with a reset function) 1 and an earth-leakage-detecting current transformer 3. The reset function-equipped switch 1 is arranged above a printed-circuit board 4 incorporating an after-mentioned earth-leakage-detection control circuit, and equipped with a function of being turned off in response to a reset signal. The earth-leakage-detecting current transformer 3 is arranged below the printed-circuit board 4 and adapted to detect an imbalance in an AC power.

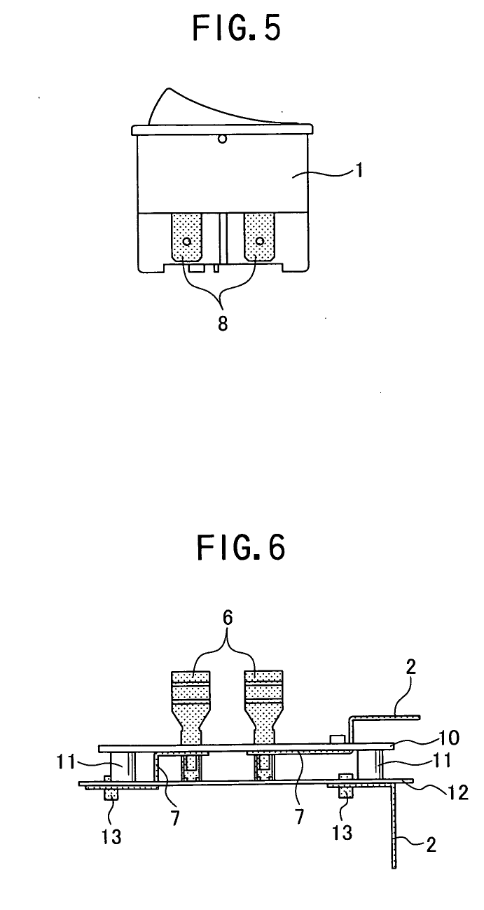

FIG. 5 is a schematic front view showing the reset function-equipped switch 1 of the earth leakage detection device in FIG. 1. As best shown in FIG. 5, the reset function-equipped switch 1 has a lower portion with front and rear surfaces each provided with a pair of switch terminals 8.

FIG. 6 is a schematic front view showing a functional block connection segment of the earth leakage detection device in FIG. 1. As best shown in FIG. 6, the functional block connection segment includes a flat plate-shaped anchor member 10 and a protection member 12. The anchor member 10 and the protection member 12 are fixedly coupled to each other through their four corner regions using four retainer members 11. The anchor member 10 is provided with first and second pairs of connection terminals 6 each adapted to come into electrical and mechanical contact with a corresponding one of the four switch terminals 8 of the reset function-equipped switch 1. While each of the connection terminals 6 may be any suitable type of terminal capable of allowing the reset function-equipped switch 1 to be detachable relative to the functional block connection segment, it is preferably formed of a Faston terminal. In this embodiment, the reset function-equipped switch 1 is formed in a configuration similar to that of a rocker switch to provide desired operational feeling so as to be additionally usable as a power switch.

The anchor member 10 is provided with a first pair of externally connecting terminals 2 for introducing an electrical power (e.g. for connection to a commercial power supply), and the protection member 12 is provided with a second pair of externally connecting terminals 2 for outputting an electrical power (e.g. for connection and power supply to a load). In this embodiment, the first pair of externally connecting terminals 2 and the second pair of externally connecting terminals 2 are disposed on the same side of the earth leakage detection device. The anchor member 10 is also provided with two first connection strips 7 each adapted to establish an electrical connection between corresponding ones of the first pair of externally connecting terminals 2 and the first pair of connection terminals 6. Further, two second connection strips 7 each adapted to establish an electrical connection between corresponding ones of the second pair of connection terminals 6 and first ends of two electrical wire members 5 in an after-mentioned earth-leakage-detection control circuit segment are disposed between the anchor member 10 and the protection member 12. The protection member 12 is designed to protect the first and second pairs of connection terminals 6 and the first and second connection strips 7.

The protection member 12 is provided with two first connection pieces 13 for electrically connecting the second pair of externally connecting terminals 2, respectively, to second ends of the two electrical wire members 5 in the after-mentioned earth-leakage-detection control circuit segment, and two second connection pieces 13 for electrically connecting the second connection strips 7, respectively, to the first ends of the electrical wire members 5 in the after-mentioned earth-leakage-detection control circuit segment. In this embodiment, each of the first and second connection pieces 13 is composed of a conductive cylindrical member arranged to penetrate the protection member 12 and a corresponding one of the second pair of externally connecting terminals 2 or the second connection strips 7. Each of the conductive cylindrical members has an outer peripheral surface electrically connected to a corresponding one of the second pair of externally connecting terminals 2 or the second connection strips 7, and a lower end formed to allow a connection protrusion 5A at each of the first and second ends of the electrical wire members 5 in the after-mentioned earth-leakage-detection control circuit segment to be detachably inserted therein so as to establish an electrical connection therebetween.

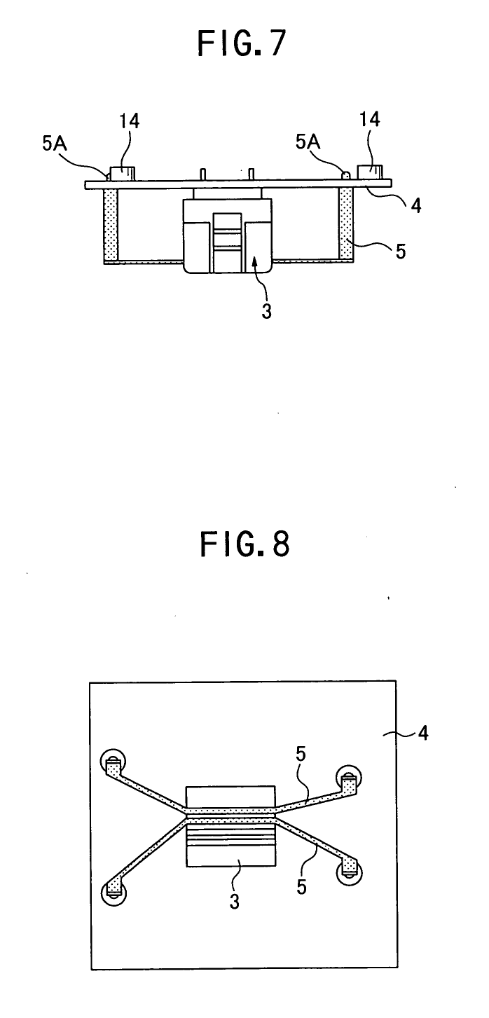

FIG. 7 is a schematic front view showing an earth-leakage-detection control circuit segment of the earth leakage detection device in FIG. 1, and FIG. 8 is a schematic bottom view of the earth-leakage-detection control circuit segment in FIG. 7. As best shown in FIGS. 7 and 8, the earth-leakage-detection control circuit segment includes the printed-circuit board 4 having an area approximately equal to that of each of the anchor member 10 and the protection member 12 in the functional block connection segment. The printed-circuit board 4 incorporates the after-mentioned earth-leakage-detection control circuit, and the earth-leakage-detecting current transformer 3 adapted to detect an imbalance in an AC power is arranged below the printed-circuit board 4. Further, the two electrical wire members 5 penetrating a core of the current transformer 3 are connected to the printed-circuit board 4. As best shown in FIG. 7, four retainer members 14 similar to the retainer members 11 in the functional block connection segment are fixed, respectively, to four corner regions of an upper surface of the printed-circuit board 4, at positions corresponding to the retainer members 11. The functional block connection segment and the earth-leakage-detection control circuit segment are adapted to be detachable relative to each other through the retainer members 11 and 14. Each of the connection protrusions 5A of the first and second ends of the electrical wire members 5 is electrically connected to the printed-circuit board 4 in such a manner as to protrude upward from the upper surface of the printed-circuit board 4.

The reset function-equipped switch 1, the functional block connection segment and the earth-leakage-detection control circuit segment described above with reference to FIGS. 5 to 8 are deigned to be detachable relative to each other, and make up the earth leakage detection device with the structure as shown in FIGS. 1 to 4 when they are assembled together. While the earth leakage detection device illustrated in FIGS. 1 to 4 is held by the bracket 15 for attachment to various apparatuses, such as a copier and a printer, as described above, the present invention is not limited to the type adapted to be held by a bracket. Further, the attachment/detachment between the functional block connection segment and the earth-leakage-detection control circuit segment may be performed by fastening the corresponding retainer members 11, 14 together in any suitable manner, such as screwing or press-fitting.

Further, with a view to allowing the reset function-equipped switch 1 to be freely arranged at an intended position of an apparatus, after the reset function-equipped switch 1 is detached from the connection terminals 6 in the functional block connection segment, the switch terminals 8 may be connected to the connection terminals 6 using appropriate harnesses.

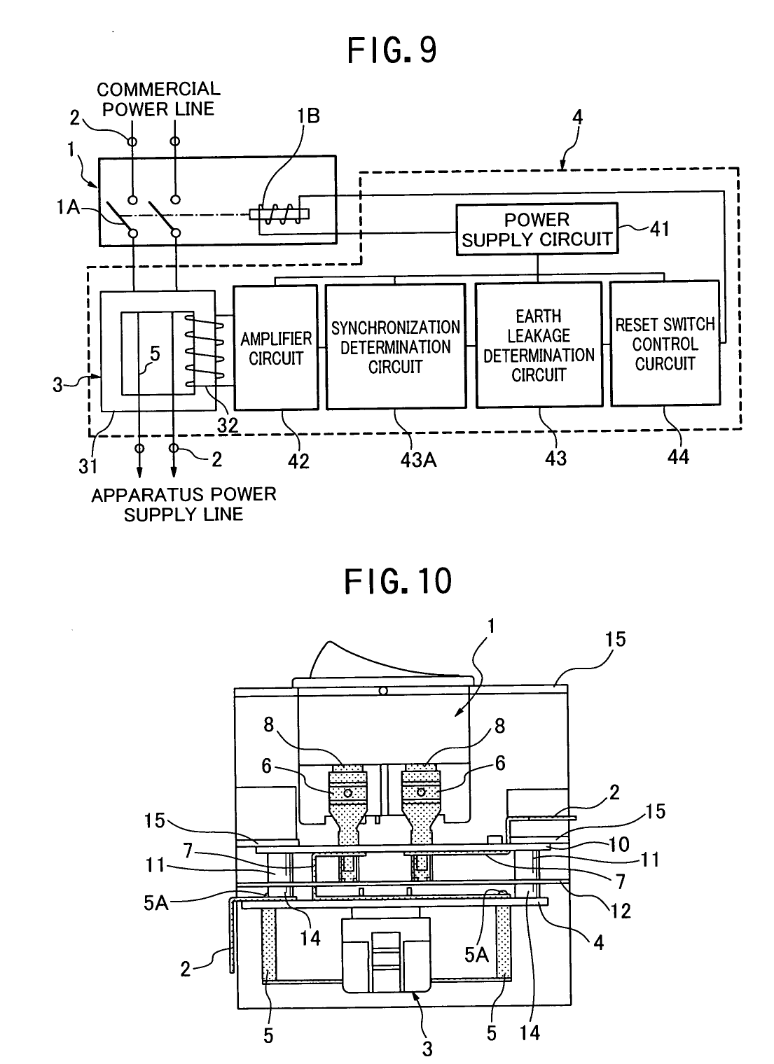

FIG. 9 is a block diagram showing an arrangement and electrical connection of each component in one example of implementation of the earth leakage detection device illustrated in FIGS. 1 to 8. With reference to FIG. 9, the detail configuration of the earth leakage detection device in this specific example will be firstly described below. As shown in FIG. 9, a power supply circuit 41, an amplifier circuit 42, a synchronization determination circuit 43A, an earth leakage determination circuit 43 and a reset switch control circuit 44 are incorporated onto the printed-circuit board 14 as an earth-leakage-detection control circuit. In this example, the earth-leakage-detecting current transformer 3 arranged below the printed-circuit board 14 includes a core 31 having a part of the electrical wire members 5 penetrating therethrough, and a secondary coil 32 connected to the amplifier circuit 42. The reset function-equipped switch 1 includes a movable contact element 1A, and a solenoid 1B for controllably turning on/off the movable contact element 1A.

In this example of implementation, the earth leakage detection device according to the above embodiment is arranged inside a housing of an apparatus, such as a copier or a printer. The second pair of externally connecting terminals 2 (on the side of the current transformer) are connected to an apparatus power supply line for supplying an electrical power to the apparatus, and the first pair of externally connecting terminals 2 (on the side of the reset function-equipped switch) are connected to a commercial power line inside the apparatus.

With reference to FIG. 9, an operation of the earth leakage detection device according to this embodiment will be described below. Upon occurrence of earth leakage in the apparatus, an imbalance voltage is induced in the earth-leakage-detecting current transformer 3 to generate a certain voltage on the secondary coil 32. This voltage signal is amplified by the amplifier circuit 42, and input into the synchronization determination circuit 43A. Then, the synchronization determination circuit 43A is operable to detect the frequency timing of the commercial power, and input the amplified voltage or current signal from the amplifier circuit 42 to the earth leakage determination circuit 43 only at a given frequency timing of the commercial power. The earth leakage determination circuit 43 is operable to compare the received voltage or current signal with a predetermined reference voltage or current, and, when the received voltage or current signal exceeds the reference voltage or current, to determine that it is at a given earth leakage level. Based on this determination, the reset switch control circuit 44 is operable to supply a current from the power supply circuit 41 to the solenoid 1B.

In response to current supply to the solenoid 1B, the movable contact element 1A of the reset function-equipped switch 1 kept in its ON state is inverted to its OFF state. In this manner, the apparatus power supply line can be turned off in response to detection of earth leakage.

The synchronization determination circuit 43A interposed between the amplifier circuit 42 and the earth leakage determination circuit 43 provides the following effect. A voltage or current signal output from the amplifier circuit 42 in connection with earth leakage has the same frequency as that of the commercial power. Thus, in the above configuration designed such that the voltage or current signal amplified by the amplifier circuit 42 is input from the synchronization determination circuit 43A into the earth leakage determination circuit 43 only a given frequency timing of the commercial power, it is highly probable that the voltage or current signal input into the earth leakage determination circuit 43 is caused by earth leakage. Thus, even if a reference voltage or current to be set in the earth leakage determination circuit 43 as a criterion of earth leakage is adjusted at a lower value to provide higher detection sensitivity to earth leakage, the synchronization determination circuit 43A makes it possible to prevent malfunction due to noises so as to maintain stable earth leakage detection.

FIG. 10 is a schematic front view of an earth leakage detection device according to another embodiment of the present invention. Except that the externally connecting terminals 2 are disposed on both opposed sides of the earth leakage detection device instead of on the same side thereof, the earth leakage detection device according to this embodiment has substantially the same configuration as that in the aforementioned embodiment described in connection with FIGS. 1 to 9. Thus, the following description will be made only about the difference therebetween. In FIG. 10, the same reference numeral used in FIGS. 1 to 9 indicates the same element or component.

In this embodiment illustrated in FIG. 10, the first pair of externally connecting terminals 2 for introducing an electrical power are disposed on the right side (in FIG. 10) of the earth leakage detection device, and the second pair of externally connecting terminals 2 for outputting an electrical power is disposed on the left side (in FIG. 10) of the earth leakage detection device. Thus, each of the second connection strips 7 is arranged to electrically connect between corresponding ones of the second connection terminals 6 (on the left side in FIG. 10) and the connection protrusions 5A (on the right side in FIG. 10; or the first ends) of the electrical wire members 5.

Some techniques of constructing the aforementioned functional block connection segment will be described below. In a first technique, a printed-circuit board is used as the anchor member 10. Further, a portion of the connection strip 7 is formed of a copper foil pattern, and each of the retainer members 11 and the protection member 12 is made of an electrical insulation material. In a second technique, each of the anchor member 10, the retainer members 11 and the protection member 12 is made of an electrical insulation material, such as plastic, and the externally connecting terminals 2 and the connection strips 7 are formed as a continuous press component. Then, the anchor member 10, the retainer members 11, the protection member 12, the externally connecting terminals 2 and the connection strips 7 are molded in a single-piece. In a third technique, each of the anchor member 10, the retainer members 11 and the protection member 12 is molded using an electrical insulation material, such as plastic, and then the connection terminals 6, the connection strips 7 and the externally connecting terminals 2 are incorporated therein individually. The present invention is not limited to these techniques, but any other suitable technique may be used.

### INDUSTRIAL APPLICABILITY

According to the present invention, components of the earth leakage detection device are arranged above and below the printed-circuit board in a compact manner using a significantly simple mechanism. Thus, the earth leakage detection device can be reduced in size and cost, and suitably arranged in a housing for various apparatuses, such as a copier and a printer.

What is claimed is:

1. An earth leakage detection device comprising:
a printed-circuit board incorporating an earth-leakage-detection control circuit;
a reset function-equipped switch mounted on the side of one of opposite surfaces of said printed-circuit board;
an earth-leakage-detecting current transformer mounted on the side of the other surface of said printed-circuit board;
an externally connecting terminal for introducing and outputting an electrical power; and
an electrical wire member arranged to penetrate through said earth-leakage-detecting current transformer and connected relative to said externally connecting terminal,
wherein said reset function-equipped switch is connected to said earth-leakage-detection control circuit with the interposition of said externally connecting terminal therebetween.

2. The earth leakage detection device as defined in claim 1, which has a functional block connection segment including a flat plate-shaped anchor member provided with a connection terminal, wherein:
said reset function-equipped switch is adapted to be detachable relative to said connection terminal;
said printed-circuit board constitutes an earth-leakage-detection control circuit segment; and
said earth-leakage-detecting current transformer and said electrical wire member are associated with said printed-circuit board.

3. The earth leakage detection device as defined in claim 2, wherein said functional block connection segment and said earth-leakage-detection control circuit segment are adapted to be detachable relative to each other.

4. The earth leakage detection device as defined in claim 2, wherein said connection terminal is a Faston terminal.

5. The earth leakage detection device as defined in claim 1, wherein said externally connecting terminal includes a first externally connecting terminal for introducing an electrical power and a second externally connecting terminal for outputting an electrical power, said first and second externally connecting terminals being disposed on the same side of said earth leakage detection device.

6. The earth leakage detection device as defined in claim 1, wherein said externally connecting terminal includes a first externally connecting terminal for introducing an electrical power and a second externally connecting terminal for outputting an electrical power, said first externally connecting terminal and said second externally connecting terminal being disposed, respectively, on opposite sides of said earth leakage detection device.

7. The earth leakage detection device as defined in claim 1, wherein said reset function-equipped switch additionally serves as a power switch.
